(19) United States
(12) Patent Application Publication
(10) Pub. No.: US 2016/0098523 A1
(43) Pub. Date: Apr. 7, 2016

(54) RECORD BUILDER

(71) Applicant: Bryan Laskin, Wayzata, MN (US)

(72) Inventor: Bryan Laskin, Wayzata, MN (US)

(21) Appl. No.: 14/963,752

(22) Filed: Dec. 9, 2015

Related U.S. Application Data
(63) Continuation-in-part of application No. 14/842,274, filed on Sep. 1, 2015.
(60) Provisional application No. 62/051,343, filed on Sep. 17, 2014.

(51) Int. Cl. G06F 19/00

(52) U.S. Cl. CPC G06F 19/322; G06F 19/325

(57) ABSTRACT

A record builder may include a device input module configured to capture an identifier for one or more devices used in a medical procedure, a data access component configured to capture procedure information for a procedure based on the identifier, an instruction interpretation component for analyzing the procedure information and identifying areas of variability, a combination assessment component configured for melding instructions relating to a plurality of devices, a detailed procedure dictator configured to prepare a dictation of the procedure, and a medical record population element configured to populate a medical record with the dictation.

### CROSS REFERENCE TO RELATED APPLICATIONS

The present application claims priority to U.S. Provisional Application No. 62/051,343, entitled Record Builder, and filed on Sep. 17, 2014 and U.S. Non-Provisional application Ser. No. 14/842,274, entitled Record Builder, and filed on Sep. 1, 2015, the content of each of which are hereby incorporated by reference in their entireties.

### FIELD OF THE INVENTION

The present disclosure relates to systems and methods for automatically generating information for an electronic medical record. More particularly, the present application relates to referencing unique device identifiers associated with a plurality of information and using the information to populate an electronic medical record. Still more particularly, the present application relates to automatically populating an electronic medical record with medical, dental, veterinarian, or other procedure steps based on a reasoned combination of information from multiple unique device identifiers of devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Dental and medical professionals and their staff provide detailed records relating to procedures performed on patients. In some cases, these detailed records may be hardcopy records or they may be in the form of electronic medical records, for example. In either case, the detailed records may reflect particular consultations, procedural steps, and the like.

In the case of a dentist, for example, when a procedure is performed to install a device or system, such as a dental crown or filling material, for example, the dentist may include several things in the patient record. In some cases, the dentist may be required by law or regulation to enter particular information in the patient record. The dentist may include and in some cases may be required to include, for example, the type, brand, manufacturer or other information about the crown or filling material. In some cases, a unique device identifier may be included allowing for tracing the device back through one or more channels of trade to the manufacturer. In addition, the dentist may include detailed notes about how the installation/procedure was performed and about other devices or materials that were used in the procedure, which may affect the steps that were used to install the device. In some cases, these detailed notes may be repeated from patient to patient for basic procedures, but in other cases these detailed notes may be quite variable based on patient needs, decisions made by the dentist before and/or during the procedure, and other factors. As such, these detailed notes may take time for the Dentist to write, type, dictate, or otherwise develop for purposes of maintaining suitable patient records.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one or more embodiments, the present disclosure relates to a record builder having a device input module, a data access component, an instruction interpretation component, a combination assessment component, a detailed procedure dictator, and a medical record population element. The device input module may be configured to capture an identifier for one or more devices used in a medical procedure. The data access component may be configured to capture procedure information for a procedure based on the identifier. The instruction interpretation component may analyze the procedure information and identify areas of variability. The combination assessment component may be configured for melding information relating to a plurality of devices. The detailed procedure dictator may be configured to prepare a dictation of the procedure. The medical record population element may be configured to populate a medical record with the dictation. Further, in some embodiment, the data access component may be further configured to capture patient diagnosis and/or treatment plans to help establish steps of the procedure. The combination assessment component may be further configured to consider patient diagnosis and/or treatment plans to help establish steps of the procedure. In addition, the data access component may be further configured to capture historic user data to help establish steps of the procedure. In embodiments, the procedure information may comprise manufacturer instructions or user preferences. The device input module may be configured for a barcode, RFID, QR, or other data scanner in some embodiments. The data access component may access a local database or a remote database in some embodiments.

The present disclosure, in one or more embodiments, also relates to a method for populating a medical record for a medical procedure. The method may include the steps of receiving a device identifier for a device used in the medical procedure, retrieving procedure information associated with the device identifier from one or more databases, analyzing the procedure information to identify areas of variability, determining appropriate variables for completing the identified areas of variability, preparing dictation of the medical procedure, and populating the medical record with the dictated medical procedure. In some embodiments, determining appropriate variables may include combining procedure information for a plurality of device identifiers, or accessing at least one of user preference data, user history data, and patient history data. The method, in some embodiments, may include determining whether the device identifier is compatible with additional device identifiers and alerting a user if the device identifier is incompatible. Receiving a device identifier may include receiving an identifier from a barcode, RFID tag, or QR code. The method may further include accessing patient diagnosis and/or treatment plans in some embodiments. In some embodiments, the procedure information may include manufacturer instructions.

The present disclosure, in one or more embodiments, also relates to a computer-implemented system for populating a medical record with a medical procedure. The system may include a user interface, a device input module accessible via the user interface and configured to capture a device identifier for one or more devices used in the medical procedure, a database comprising procedure information associated with device identifiers, a data access component configured to access the database and capture procedure information for a procedure based on the identifier, an instruction interpretation component configured to analyze the procedure information and identify areas of variability, a combination assessment component configured to meld information relating to a plurality of devices, a detailed procedure dictator configured to prepare a dictation of the procedure, and a medical record population element configured to populate a medical record with the dictation. In some embodiments, the database may further include patient data, and the data access component may be further configured to capture patient diagnosis and/or treatment plans to help establish steps of the procedure. The combination assessment component may be further configured to consider patient diagnosis and/or treatment plans to help establish steps of the procedure. In some embodiments, the database may be accessible over a network.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram showing a record builder in communication with a network, according to some embodiments.

FIG. 2 shows a more detailed diagram of the record builder of FIG. 1, according to some embodiments.

FIG. 3 depicts a method of building a medical record, according to some embodiments.

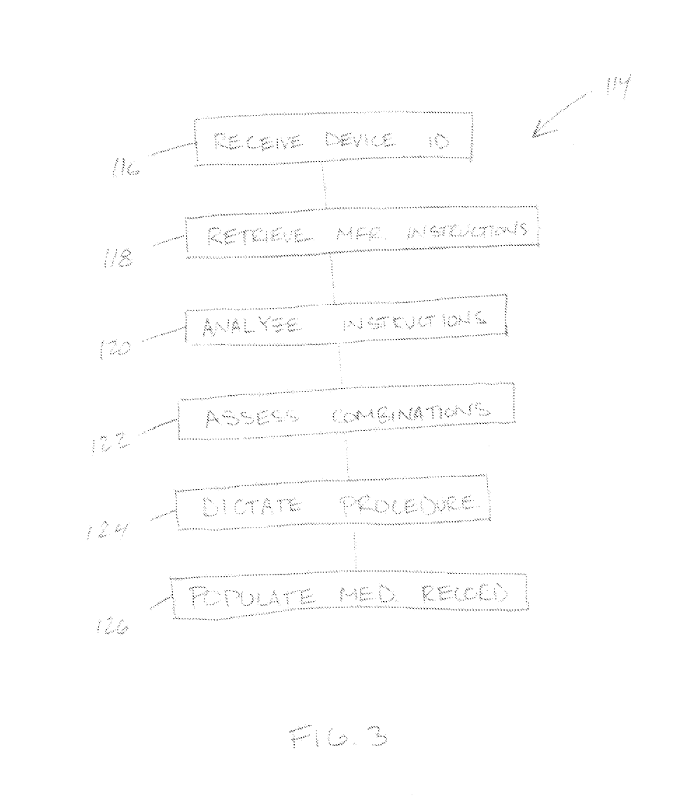

FIG. 4 shows a detailed diagram of a tool for filling openings in a patient schedule, according to one or more embodiments.

FIG. 5 depicts a method of filling an opening in a patient schedule, according to one or more embodiments.

### DETAILED DESCRIPTION

The present application, in some embodiments, relates to a record builder system that automatically develops a detailed record relating to a procedure performed on a patient based on the types of devices used in the procedure. For example, the system may rely on a unique device identifier (UDI) or other identifier database or databases that includes information relating to a medical device. It is to be appreciated that a medical device may include an actual device, a system, a material used to secure, anchor, pre-treat or otherwise interact with the device prior to or during use or implantation. In other cases, a medical device may be a tool used to perform a procedure on a patient. Still other items may be considered medical devices that the current system may be used with to develop a record. In any of these cases, the UDI or other identifier or other features of the device or its packaging may be used to identify the manufacturer of the device and other details distinguishing the device from other devices. In some cases, the UDI or other identifier of the device or packaging may be used to identify particular user preferences or user operations that may be unique to each device. In addition to the above-mentioned information, the database or databases may also include manufacturer instructions relating to the installation and/or use of the device. In many cases, these manufacturer's instructions allow for more than one approach to using the device or system and the various approaches may be affected by preferences of the medical professional, the other materials or systems the device is used with, the availability and suitability of other materials or devices, and other factors. As such, the actual steps performed during a procedure may be affected by these other factors causing the detailed medical record to vary from case to case. However, where the device and the other systems or devices it is used with are known, the manufacturing instructions or other information may be used to prepare a detailed record because the variability in the instructions may be defined by reference to the other systems or devices that are used.

The system may be used by surgeons, clinicians, dentists, veterinarians, and other medical professionals or in other situations where acts may be anticipated based on the materials and/or devices that are used. The system may provide for inputting a series of identifiers, such as UDI's, that reflect a plurality of devices, systems, or materials used in a particular procedure. In some embodiments, the system may then access a database or databases to obtain manufacturer's instructions for the several devices, systems, or materials and may rely on the several sets of manufacturer's instructions to develop a detailed record of the procedure. In other embodiments, the system may access a database or databases to obtain a user's instructions or approach for using the several devices, systems, or materials to develop a detailed record of the procedure. The system may then place that detailed record into a patient's electronic medical record, for example. There may also be opportunity for a user to review and/or edit the dictated procedure.

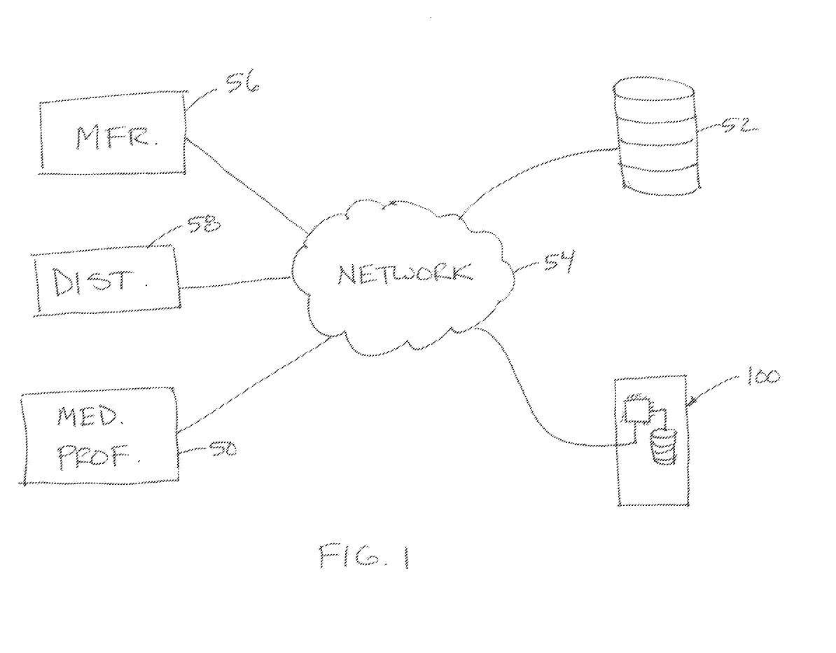

Referring now to FIG. 1, a record builder 100 available over a network to a medical professional 50, or at the location of the medical professional, is shown in communication with one or more databases 52 via a network 54. In addition, a manufacturer or supplier 56, distributor 58, or other entity that may come into contact with or otherwise be involved with a medical device may also be in communication with the one or more databases 52 via the network 54.

It should be appreciated that unique device identifiers are becoming more prevalent and, in some cases, are required by regulatory authorities for purposes of tracking and/or tracing information about a particular medical device, material, or system. In light of these identifiers, the present application contemplates one or a series of databases 52 that may be maintained by the entities in the lifecycle of a medical device from manufacturing to patient installation or use. For example, the entities may include a manufacturer 56, a distributor 58, and a medical professional 50. Other entities coming into contact with the device may also be included. In some cases, each of these entities may maintain its own database 52 including a unique device identifier together with information that is relevant to the entity's relationship with the device. In other embodiments, one or more of the entities may collaborate to rely on a collaborative database 52 for capturing the information relevant to each entity's interaction with a device. In still other embodiments, a third party vendor may host and maintain one or more of the database or databases 52 and one or more of the several entities may interact with the third party vendor to maintain and/or keep the database 52 up to date regarding one or more devices.

Each entity in the lifecycle may be responsible for associating (or required by regulations to associate) particular types of information with the device. In the case of the manufacturer 56, the database 52 may be maintained and may include a unique device identifier in conjunction with a serial number, lot number, and/or other information allowing for details about the device and its manufacturing to be later determined. These details may include materials (i.e., SDS information), assembly drawings, part drawings, manufacturing dates, manufacturer's instructions for implementation and use, and other commonly collected manufacturing information. This may be maintained such that information about a particular device may be available should there be issues of recall, questions about materials used, or other inquiries about a medical device. In the case of other entities, for example distributors 58, the database 52 may include a listing of unique device identifiers together with dates, shelf times, shipping modes and dates or other logistical information that is relevant to the interaction with the device by the distributor 58. In the case of a medical professional 50, the database 52 may include the unique device identifier together with storage times, user preferences, and patient information including, for example, patient names, procedure dates, procedure information and the like. Still other entities that “touch” a medical device between its lifecycle from manufacturing to patient installation and/or use, may have information that is stored in one or more databases 52.

As shown, the present system may be provided via the cloud or otherwise offered over a network such as the Internet. In these cases, one or more databases 52 may be affiliated with the system 100 such that information particular to a medical professional 50 or other user (i.e., customized, practice focused, and potentially patient specific information) may be stored on the system. In still other embodiments, for purposes of privacy, storage of customizations, patient information, and the like may be stored on the medical professional's 50 or user's system. In any case, the present system 100 may access one or more databases 52 via a network 54. The network 54 may be a wide area network such as, for example, the Internet, or a local area network may be used. For example, where a database 52 hosted by another entity is relied on for supplying device information, a wide area network may be utilized. However, where the information used by the system 100 is previously installed, downloaded, or otherwise stored on the using entity's system, a local area network, for example, may be provided. In still other embodiments, where information relied on by the system 100 (i.e., manufacturer's instructions) is provided with the device, use of the network may be avoided to access the data. For example, where a bar code, RFID tag, QR code, or other computer readable storage system contains manufacturer's information, the system may access this information directly using a reader or other information capturing device.

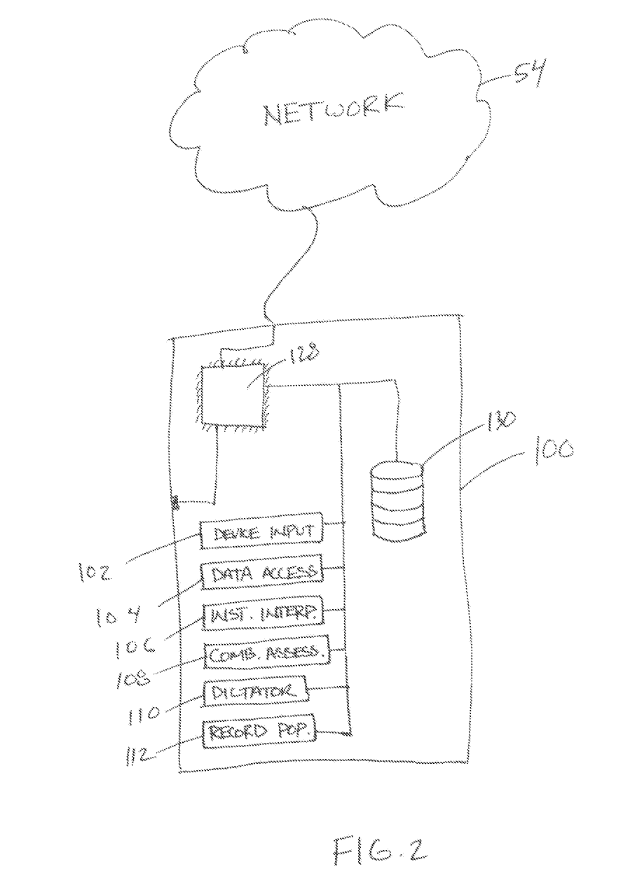

Having discussed the related infrastructure that the system may be used on or with, reference is made to FIG. 2 for a discussion of the record builder 100 in detail. As shown in FIG. 2, the record builder 100 may include a device input module 102, a data access component 104, an instruction interpretation component 106, a combination assessment module 108, a detailed procedure dictator 110, and a medical record population element 112. These several components, elements, and/or modules, may include software, hardware, or a combination of software and hardware configured to perform a particular function. Moreover, while each of these components, elements, and/or modules is described herein separately, each of them may be combined with one or more of the other components, elements, and/or modules. The record builder 100 may also include a processor 128 and a computer readable storage medium 130.

The device input module 102 may be configured to collect identifiers, such as unique device identifiers, for each device, system, material or other aspect of a medical procedure. That is, before, during, or after a procedure, a medical professional 50 or staff may interface with the device input module 102 to input the several devices, systems, or materials used for a particular medical procedure. This interaction with the device input module 102 may be via a locally provided interface at a medical professional's 50 location and via a local computing device. The local computing device may comprise a system 100 or the local computing device may access or interface with the system 100 via a network 54. In some embodiments, the device input module 102 may be configured for use with or may include a reader that may be used to scan packaging or other aspects of a device to capture an identifier or other more substantial information. The reader may include, for example, a barcode scanner, RFID scanner, QR code scanner, photographic software identification system, or other scanning device, which may be on a mobile device an electronic scanner or other reading device. In other embodiments, a user interface may be used to manually input or look up one or more identifiers in a pre-populated database. Still other forms of input may be provided such that the user may inform the system of the one or more devices, systems, or materials used in a particular procedure. The user may exercise judgment when inputting identifiers and may, for example, omit identifiers for routine devices, such as drills, scalpels, scissors, and the like that may not have an effect on the record generated. In some embodiments, the user may select items for input that are likely to remain within the body or have the potential to remain within the body. In other cases, the user may select devices that are particular to the procedure being performed, whether remaining within the body or not. In still other embodiments, the user may use other metrics for determining whether to input a device.

The data access component 104 may be configured to capture record related information such as manufacturer's instructions for one or more medical devices, systems, materials and the like. That is, given the identifying information obtained by the device input module 102, the system may be poised to gather information about each of the devices used for a particular procedure. The data access component 104 may work through each of the identifiers obtained by the input module 102 and may access the one or more databases 52 and/or 130 via a network or locally. The database or databases 52, 130 may be used to capture information, such as manufacturer's instructions, for each device and store the instructions in the system 100.

In addition to manufacturer's instructions, the data access component 104 may rely on and/or capture other available information as well. For example, the data access component 104 may track and develop tendencies toward particular procedures when supplied with a particular device or material. That is, the system may rely on historical uses by the medical professional to help focus in on the likely procedure being performed or to establish answers to variables delineated in the manufacturer's instructions. Such historical data may be stored in a database 130, for example. In other embodiments, the data access component 104 may review a patient's medical record for information relating to diagnosis and/or a treatment plan allowing the system to narrow down the procedures likely to be performed. For example, the data access component 104 may access a medical record stored on the professional's system at the professional's location 50. In some embodiments, multiple procedures may be identified allowing the system to avoid confusion when multiple devices are used that may not seem consistent with one another based on the manufacturer's instructions. In other embodiments, software analysis of radiographic or other diagnostic information may offer clues to the system regarding the procedure being performed. In other embodiments, past data in the patient's record, past records in the user's database (user history) or data from accompanying software (diagnostic applications) may be relied on. In some particular examples, the system may rely on GPS or other location identification systems to determine the time and location that the procedures were performed.

It should be appreciated that the data access component 104 may rely on varying levels of customization and user input. For example, some users may spend time providing dictation data for particular devices, materials, or systems or a series of dictation data sets for particular devices, materials, or systems. When these respective devices are identified by the device input module, the data access component 104 may readily capture one or a series of related dictations or data sets relating to these devices. The data access component 104 may, for example, have a series of priorities where locally stored preferences or data may be checked first and third party databases may be checked second, for example.

In some embodiments, the user may be provided with a creation tool allowing the user to create their own sets of identifiers. For example, the user may create an internal set of bar codes or other identifiers specific to the user and the users practice. In this example, the user may then create and rely on a series of stickers or labels that the user applies to devices for purposes of scanning when the device is used. Alternatively, the user may create a chart of stickers or labels or a book of stickers or labels, for example, that may be used to scan when a respective device is being used or installed. As another example, the creation tool may allow a user to input a photo of an object or another aspect of the object such as a scan of the packaging or photo of the packaging or label to be used as the identifier.

With these identifiers, the user may associate particular dictation information with these identifiers individually or in groups. For example, for a particular device that, when used alone, is typically used in one procedure, but when used in conjunction with another device or tool is typically being used in a different procedure, differing dictation information may be associated with these identifiers in the solo condition and the combined condition. In this manner, using the creation tool, the user may create their own identifiers and may also create dictation information or notes based on those identifiers when they occur alone or in any number of combinations with each other.

The instruction interpretation component 106 may be configured to delineate areas of variability for each device identified by the device input module. For example, where a particular device may be implanted, installed, or used in one of a plurality of ways based on manufacturer's instructions, the instruction interpretation component 106 may set up a computer variable allowing for the instructions or procedural dictation to be adapted depending on other input relating to other devices being used. In some cases, the setting up of a variable may include noting or identifying incompatible materials for use by the combination assessment module 108, described below. The instruction interpretation module 106 may, thus, create a decision tree or other computer algorithm allowing the instructions to be converted to a description of a medical procedure. For example, where a dental crown has instructions relating to adhering the crown with one or more materials, the system may identify the adhering material as a variable and may establish a decision tree allowing the input of a material type to define the procedural description. The decision trees, matrices, or other computer-based forms of the instructions may be stored by the system.

In addition to interpreting and logically combining the information from the several sets of manufacturing instructions, the instruction interpretation component 106 may rely on one or more aspects of the information captured by the data access module 104 outside of the manufacturer's instructions. This information may include a patient diagnosis or treatment plan, user history/preferences, or other informational elements made available by the data access module 104. In particular, the instruction interpretation component 106 may rely on customized user procedures for particular devices. For example, one or more users may initially input manufacturer's instructions for a particular device and the user may identify areas of variability to help establish the decision tree used by the system to develop a dictation relating to the device. The system may rely on the user input for the present device and for future instances of that device. In some cases, the system may leverage input by one user and may store the instructions in a database 130 and make that input available to other users for describing a procedure for a same or similar device that the other users are using. As such, the available information about a particular device or series of devices may develop quickly when multiple users are relying on the system.

The combination assessment module 108 may be configured to combine the several sets of instructions obtained and analyzed by the instruction interpretation component 106. That is, for example, having analyzed and interpreted the instructions, a primary device may have a series of variables that may affect the procedure and the related medical record. The combination assessment module 108 may, thus, scan or review the several computer-based forms of the instructions to identify answers to variable questions in the primary device. For example, if an adhering material variable has been identified by the instruction interpretation component 106, the combination assessment module 108 may scan the related devices input with the device input module 102 to determine if the adhering material is found. Where it is, at least a portion of the decision tree may be completed. The combination assessment module 108 may continue to review the several computer-based forms of the instructions to answer any/all variables in the primary device instructions until all variables are found and included in the algorithm. In some embodiments, where a variable remains unanswered, the user may be prompted to address such a variable. For example, where an adhering material is omitted from the input process, the system may prompt the user by asking what the adhering material being used is. A user may, thus, fill in any gaps in the instructions not readily answered by inputting the information with the device input module 102.

In addition, the combination assessment module 108 may rely on other information outside the manufacturer's instructions as mentioned above to combine systems and develop the likely procedure being performed. In some embodiments, users may develop probable procedures, for example, based on a series of devices. That is, for example, if a crown is being placed for a patient with a particular adhesive, the user may customize the system to jump to a likely procedure once the crown and adhesive are input into the system. Still other procedures with 1, 2, 3, or more devices may be input by the user and associated with likely procedures. Still further, additional devices that are used occasionally for complication, for example, may be identified as such so a particular procedure may be appended with additional information relating to the use of an additional, but otherwise somewhat separate device.

In still other embodiments, the system may identify and alert the user if incompatible materials are identified. In this embodiment, the combination assessment module 108 may review lists of incompatible or undesirable materials for a particular variable established by the instruction interpretation component 106, for example. Where the combination assessment module 108 finds an incompatible material and/or device, the system may alert the user by listing the potential issues of continuing with the material or device combination.

The detailed procedure dictator 110 may develop the detailed statements describing the procedure that was performed. That is, with the combination assessment module 108 finished, the start-to-finish steps of the procedure may be defined including all of the variables in the procedure. The dictator 110 may, thus, transpose the manufacturer's instructions or other user instructions or forms into a description of the procedure describing the procedure in past tense and stating that particular steps instructed by the manufacturer or otherwise identified by the user have been performed. The dictator 110 may dictate the steps of the procedure in chronological order or other organizational patterns may be used.

The medical record population element 112 may be configured to populate a patient's medical record with the procedure description. For example, the medical record population element 112 may access a patient's medical record and may identify the field or fields that this information is suitable for. The population element 112 may then input the procedure description into one or more fields in the record. It is to be appreciated that where electronic medical records are not in use, the system may create a printable report or other electronic document that may be used to populate a hard copy record for the patient files. The medical record population element 112 may also prompt the user with the dictated record for purposes of review and verification. This may allow a medical professional to confirm that the procedure was suitably and accurately captured.

In addition to the dictated procedure, the system may also automatically provide for clinic notes, walk out statements (billing), inventory controls, scheduling appropriate follow-up (lab communications, patient after care, etc), changing the EMR to reflect the procedure completed, notifying insurance, or automatic charges (for example credit card on file, or outside financing), etc. Still other ancillary or other procedures may be performed based on capturing the device information.

The present system may be advantageous because it may be able to create a description of a procedure based on the devices and systems that are used and the system may reduce or eliminate the efforts on the part of the professional to dictate or otherwise manually record the procedure description.

In operation, the system may perform a method 114 to produce a dictation of a procedure based on the devices used. A medical professional, staff, or other user may scan or input one or more medical devices, systems, materials, or other elements being used in a procedure on a patient and the system may receive the device information, such as an identifier using the device input module. (116) The scan may be performed while the patient information is accessed (i.e., pulled up in an interface), such that the device information is automatically associated with the patient and may allow the system to quickly access other information about the patient when establishing the procedure being performed. The device input module may capture this information upon scanning or otherwise inputting this information. The data access component may retrieve device information, such as manufacturer's instructions by accessing external and/or internal databases 52/130 or information to capture information that may help to define the procedure. (118) The data access component may access a database and capture manufacturer instructions or other instructions provided by the user, for example, for each of the scanned devices or elements. The data access component may also access other information such as patient diagnosis, treatment plant, user history and other information discussed as being capturable by the data access component. The instruction interpretation module may then analyze the instructions to ascertain and establish variability in the instructions. (120) The combination assessment module may then review other device information scanned to answer and/or fill in the variables identified. (122) In some cases alerts for incompatible materials may be issued. The combination assessment module may also rely on other information aside from the manufacturer's instructions to find answers to variable questions. The detailed procedure dictator may rely on the process outlined by the combination assessment module to produce a dictated procedure. (124) The medical record population element may then prompt the user for review of the procedure and populate the electronic medical record and/or perform additional tasks. (126)

The following examples are provided to explain how the above-described system may be used. Nothing in these examples should be construed to limit the scope of the disclosure to the particular methods described.

In a first example, an all-ceramic crown may be provided. In this case, it may be common to place a silane to the intaglio (undersurface) of the crown, then an adhesive and finally a resin cement. All these materials (silane, ceramic, adhesive, and resin cement) may be identified in some way, either by UDI scan, product input in database, barcode, etc. using the device input module. By having the specific identifiers, the system may extrapolate how these products are used together. The resulting procedural dictation may be something like “Interface brand 2-part silane used by allowing A and B parts to sit for 20 seconds, vigorously stirred for 5 seconds then placed on the cleaned intaglio surface of the Empress ceramic restoration, let sit for 30 seconds and air dried for 5 seconds. Parts A and B of Clearfil DC bond was then mixed and immediately placed on the dried tooth surface with vigorous scrubbing for 15 seconds, air dried 5 seconds and lightcured using 3M Elipar curing light (also scanned, or in user's database as their curing light of choice) for 10 seconds. Clearfil Majestic Resin cement then placed on the intaglio surface of the restoration, held in place and allowed to gel set prior to peeling excess, then light cured with 3m Elipar curing light for 10 seconds, buccal, lingual, and occlusal.” This procedural dictation may be developed by modifying or adjusting the primary device instructions (i.e., ceramic crown instructions) to include material information such as silane, adhesive, and resin.

In another example, where a different material was being used for the crown (for example an Composite resin crown) where the bond may be weakened by using silane, the system may alert the user that these materials are not recommended to be used together. The system may also cross reference materials with patient history and provide such alerts relating to allergies, patient preferences, and the like.

Some product combinations may call for different usage and the system may extrapolate that. For example, if a gold metallic crown was being used in the above case, the system may know that light curing through metal is likely to be unworkable, so the system may adjust the details to eliminate the light curing of the resin cement to “held in place for 5 minutes”, or something appropriate for that material.

The system may extrapolate the particular procedures being performed based on the devices and/or materials identified. In the above case, defining the all-ceramic crown, silane, adhesive and resin cement may be enough for the system to know that an all-ceramic crown cementation procedure was being performed. If additionally a direct resin was identified (filling material), the system may know that both a crown cementation and filling were being performed and those details may be populated. Combining this with the EMR/patient record which would include the patient's treatment plan, the system may know which teeth the procedures were performed on, and create the appropriate clinic notes, walk out statement (billing), inventory controls, schedule appropriate follow-up (lab communications, patient after care, etc), change the EMR to reflect the procedure completed, notify insurance, and/or automate charges (for example credit card on file, or outside financing), etc.

In another example, when diagnosing a tooth that is necrotic (dead) it is common to use “endo ice” a refrigerant. If every tooth is responsive to cold, but one is not, that tooth is most likely dead, and likely requires a root canal or extraction. In this context, the system may extrapolate from the identification of endo ice being used, and other factors that all the teeth on that side of the mouth and the corresponding contralateral tooth was tested, everything was “within normal limits” to cold (responsive), except for the tooth being worked on. The “other factors” (not endo ice) could include things like:
a. Software analysis of radiographic or other diagnostic information
b. Treatment plan input in the record
c. Past data in the patient's record
d. Past records in the user's database (user history)
e. Additional information provided by user to software
f. Data from accompanying software (diagnostic applications)

In some particular examples, the system may rely on GPS or other location identification systems to determine the time and location that the procedures were performed.

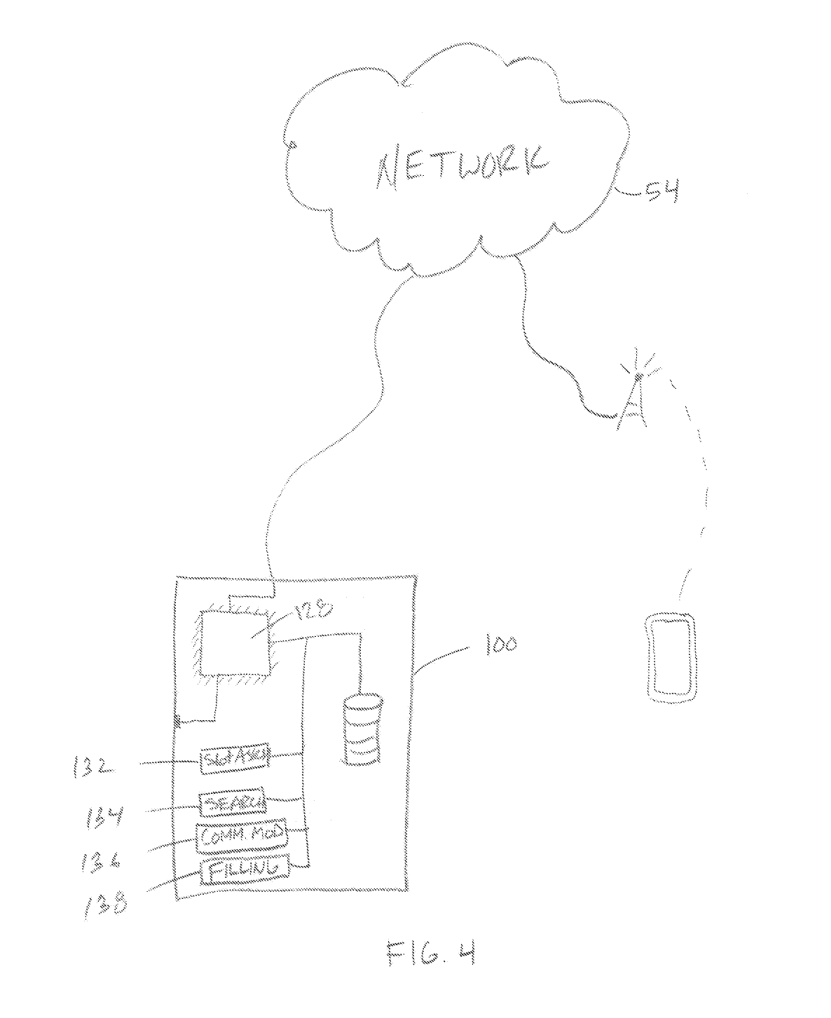

In some embodiments, as shown in FIG. 4, a tool for refilling or backfilling an appointment calendar may also be provided. For example, it is common for dentists or other professionals to schedule appointments throughout the day and it can be advantageous and profitable to make efficient use of the schedule and have a consistent schedule of appointments throughout the day such that down time for the dentist is reduced and/or avoided. However, it is not uncommon for patients or other patrons to call on relatively short notice and cancel their appointment. In an effort to maintain efficient use of time and remain profitable, several phone calls may be made by the dentist's staff to make every effort to find another patient to fill the new vacancies. These staff may take a wide range of factors into consideration when attempting to fill the vacancies and then must go through the painstaking process of calling a litany of people in an effort to fill the vacancy.

The present system may include a tool for automating the refilling or backfilling process. In some embodiments, the tool may include a slot assessment module 132, a search module 134, a communication module 136, and a schedule filling module 138. The several modules may function to identify suitable candidates to refill the vacancy, reach out to and get confirmation from one or more candidates of a desire to refill the vacancy, and update the schedule with the selected candidate.

The slot assessment module 132 may be configured to assess the time slot for which services have been cancelled and identify parameters for which a suitable replacement may be determined. In some embodiments, the slot assessment tool 132 may consider the length of the appointment that was scheduled, the type of procedure that was scheduled, the staffing requirements for the procedure and other factors. In some embodiments, the slot assessment tool 132 may identify the medical devices, materials, or systems that were going to be used for the scheduled appointment such as by retrieving UDI information about such devices, materials, or systems. In some embodiments, many of these parameters may be captured by considering the procedure code or billing code associated with the scheduled appointment and as such, the slot assessment tool 132 may consider retrieving this information in addition to or as a proxy for one or more of the other parameters.

The slot assessment module 132 may, thus, capture the name, patient ID, or other identification information relating to the cancelling patient. The slot assessment module 132 may then access system records to determine one or more of the parameters relating to the originally scheduled appointment.

The search module 134 may be configured to receive the parameters from the slot assessment module and identify candidates that may be suitable to fill the scheduled cancellation. The search module 134 may, thus, access system records to identify patients that have planned procedures and whose procedures are also consistent with the parameters. The search module 134 may then compile a list of potential candidates. In some embodiments, exact matches may not be available and weights may be provided to the parameters to allow the system to identify the closest matches available. The search module 134 may then compile the matches in priority order where patients whose procedures match the cancelled procedure the closest are listed first and patients whose procedures vary from the cancelled procedure are listed later according to how closely they match the cancelled procedure.

The communication module 136 may be configured to communicate the schedule opening to one or more of the patients identified by the search module. In some embodiments, a communication may be sent to every identified patient. In other embodiments, a communication may be sent to patients with matching procedures first and communications may be sent to patients with non-matching procedures at a later time. The communication module 136 may consider the amount of time remaining between the current time and the time of the cancellation in determining how aggressively to pursue finding a replacement. In some embodiments, patients with distant appointments may be targeted as an opportunity to get them in sooner. In other embodiments, patients that are scheduled in less preferable time slots may be targeted as an opportunity to get them in at a more preferable time.

The communication module 136 may use one or more methods of communication including text, e-mail, automated voice messaging, Facebook, or other communication systems to contact the candidates for filling the schedule. In particular, the communication module 136 may access system records to retrieve phone numbers, e-mails, or other contact information for each of the candidates and may send individual or mass communications in an effort to reach the potential candidates. In some embodiments, the communication may allow for a reply or in some embodiments, it may prompt the candidate to call, e-mail, text, or otherwise confirm an interest in filling the cancellation. In other embodiments, the communication may include a link to a website allowing the patient to access the website and confirm an interest in filling the appointment.

The schedule filling module 138 may be configured to receive responses from the potential candidates. In particular, the schedule filling module may receive a communication and identify the patient sending the communication. In some embodiments that may involve capturing the phone number or e-mail from which the communication was received and accessing system records to match it up with a patient name. In other embodiments, where, for example, the communication to the candidates includes a link to a website, the website may ask the patient to enter their name in addition to indicating a desire to fill the vacancy on the schedule. Once the schedule filler has identified the patient, the schedule filler may access the scheduling database and add the patient to the schedule in the place of the patient that cancelled.

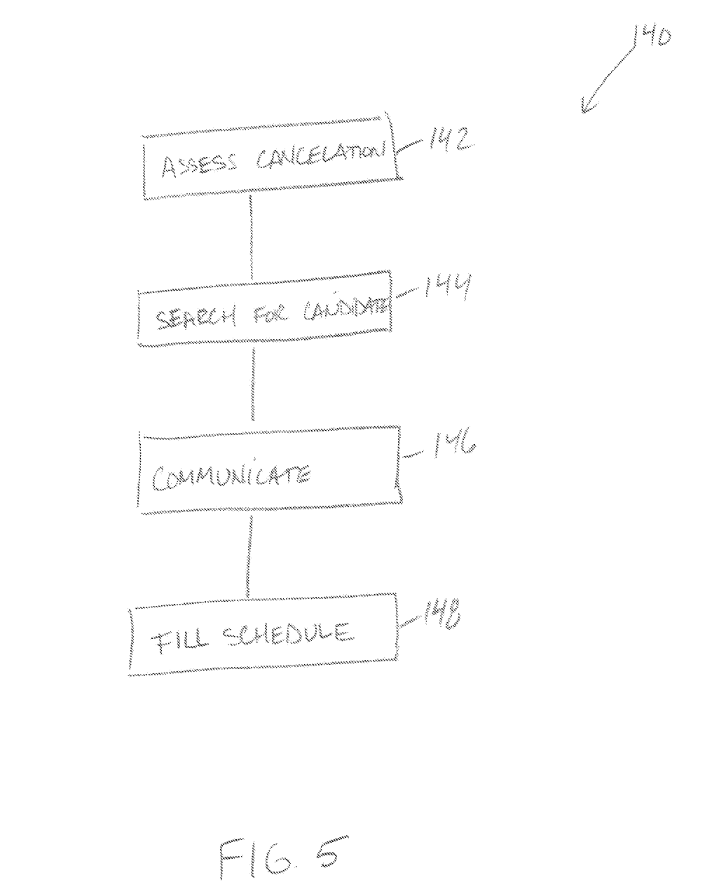

As shown in FIG. 5, the tool described with respect to FIG. 4 may be used to perform a scheduling filling method (140). That is, the system may assess the opening in the schedule due to the cancellation and capture parameters of the cancelled appointment or patient. (142) The system may also search for potential replacement patients or candidates based on the parameters identified and/or selected in the assessing operation. (144). The system may then communicate to one or more of the candidates to make them aware of the schedule opening. (146). The system may then receive return communication and fill the schedule with a selected candidate. (148).

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A record builder, comprising:
a device input module configured to capture an identifier for one or more devices used in a medical procedure;
a data access component configured to capture procedure information for a procedure based on the identifier;
an instruction interpretation component for analyzing the procedure information and identifying areas of variability;
a combination assessment component configured for melding information relating to a plurality of devices;
a detailed procedure dictator configured to prepare a dictation of the procedure; and
a medical record population element configured to populate a medical record with the dictation.

2. The record builder of claim 1, wherein the data access component is further configured to capture patient diagnosis and/or treatment plans to help establish steps of the procedure.

3. The record builder of claim 2, wherein the combination assessment component is further configured to consider patient diagnosis and/or treatment plans to help establish steps of the procedure.

4. The record builder of claim 1, wherein the data access component is further configured to capture historic user data to help establish steps of the procedure.

5. The record builder of claim 1, wherein the procedure information comprises manufacturer instructions.

6. The record builder of claim 1, wherein the procedure information comprises user preferences.

7. The record builder of claim 1, wherein the device input module is configured for a barcode, RFID, QR or other data scanner.

8. The record builder of claim 1, wherein the data access component accesses a local database.

9. The record builder of claim 1, wherein the data access component accesses a remote database.

10. A method for populating a medical record for a medical procedure, comprising:
receiving a device identifier for a device used in the medical procedure;
retrieving procedure information associated with the device identifier from one or more databases;
analyzing the procedure information to identify areas of variability;
determining appropriate variables for completing the identified areas of variability;
preparing a dictation of the medical procedure; and
populating the medical record with the dictated medical procedure.

11. The method of claim 10, wherein determining appropriate variables comprises combining procedure information for a plurality of device identifiers.

12. The method of claim 10, wherein determining appropriate variables comprises accessing at least one of user preference data, user history data, and patient history data.

13. The method of claim 10, further comprising determining whether the device identifier is compatible with additional device identifiers, and alerting a user if the device identifier is incompatible.

14. The method of claim 10, wherein receiving a device identifier comprises receiving an identifier from a barcode, RFID tag, or QR code.

15. The method of claim 10, further comprising accessing patient diagnosis and/or treatment plans.

16. The method of claim 10, wherein the procedure information comprises manufacturer instructions.

17. A computer-implemented system for populating a medical record with a medical procedure, comprising:
a user interface;
a device input module accessible via the user interface and configured to capture a device identifier for one or more devices used in the medical procedure;
a database comprising procedure information associated with device identifiers;
a data access component configured to access the database and capture procedure information for a procedure based on the identifier;
an instruction interpretation component configured to analyze the procedure information and identify areas of variability;
a combination assessment component configured to meld information relating to a plurality of devices;
a detailed procedure dictator configured to prepare a dictation of the procedure; and
a medical record population element configured to populate a medical record with the dictation.

18. The system of claim 17, wherein the database further comprises patient data, and wherein the data access component is further configured to capture patient diagnosis and/or treatment plans to help establish steps of the procedure.

19. The system of claim 18, wherein the combination assessment component is further configured to consider patient diagnosis and/or treatment plans to help establish steps of the procedure.

20. The system of claim 17, wherein the database is accessible over a network.

21. A schedule filler, comprising:
an assessment module configured to assess cancellation parameters associated with a patient procedure that has been cancelled due to a cancelled appointment;
a search module configured to search for approaching appointments having parameters that are the same or similar to the cancellation parameters and identify a candidate to fill the cancelled appointment;
a communication module configured to communicate a schedule opening to the candidate; and
a filling module configured to receive a communication from the candidate and fill the schedule opening.

22. The schedule filler of claim 21, wherein the cancellation parameter includes a proxy for a series of parameters.

23. The schedule filler of claim 22, wherein the proxy is a procedure code.
